(19) United States
(12) Patent Application Publication
(10) Pub. No.: US 2016/0063565 A1
(43) Pub. Date: Mar. 3, 2016

(54) MARKETING PLATFORM THAT DETERMINES ADVERTISEMENTS FOR THIRD PARTY USERS

(71) Applicant: Verizon Patent and Licensing Inc., Arlington, VA (US)

(72) Inventor: Ashok N. SRIVASTAVA, Mountain View, CA (US)

(21) Appl. No.: 14/472,756

(22) Filed: Aug. 29, 2014

(51) Int. Cl. G06Q 30/02

(52) U.S. Cl. CPC G06Q 30/0269

(57) ABSTRACT

A device receives user information associated with users of user devices of a network, and receives marketing information associated with products or services. The device generates user profiles, associated with the users, based on the user information, and receives information relating to a third party user. The third party user is associated with a third party user device, the third party user device is associated with a third party network, and the third party network is different than the network. The device determines, based on the information relating to the third party user and the user profiles, a third party user profile for the third party user, and determines an advertisement to provide to the third party user device based on the third party user profile and the marketing information. The device causes the advertisement to be provided to the third party user device, via the third party network.

### BACKGROUND

Users today utilize a variety of user devices, such as cell phones, smart phones, tablet computers, etc., to access online services (e.g., email applications, Internet services, television services, etc.), purchase products and/or services, and/or perform other tasks.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 depicts a flow chart of an example process for determining advertisements for third party users of a third party network; and

FIGS. 5A-5F are diagrams of an example relating to the example process shown in FIG. 4.

### DETAILED DESCRIPTION OF PREFERRED EMBODIMENTS

The following detailed description refers to the accompanying drawings. The same reference numbers in different drawings may identify the same or similar elements.

Information associated with user devices (e.g., locations of the user devices when tasks are performed, times associated with when the user devices perform the tasks, network resources utilized by the user devices, etc.) and information associated with content accessed by the user devices (e.g., clickstream information associated with the user devices) may be collected by a provider of a network. Information associated with the users (e.g., preferences and other information) may be shared with vendors (e.g., businesses, organizations, etc.) that provide products and/or services so that the users can access and interact with the vendors in an efficient manner.

Vendors are constantly trying to find out as much about users as possible so that the vendors can market appropriate products and/or services to the users via advertisements (ads). However, most vendors know very little about the users of their products and/or services. The vendors may utilize multiple marketing channels (e.g., online advertisements, email advertisements, etc.) to provide the advertisements to the users. Thus, the vendors are also constantly trying to figure out how to allocate a marketing budget so that appropriate advertisements are provided to appropriate users at appropriate times and via appropriate marketing channels.

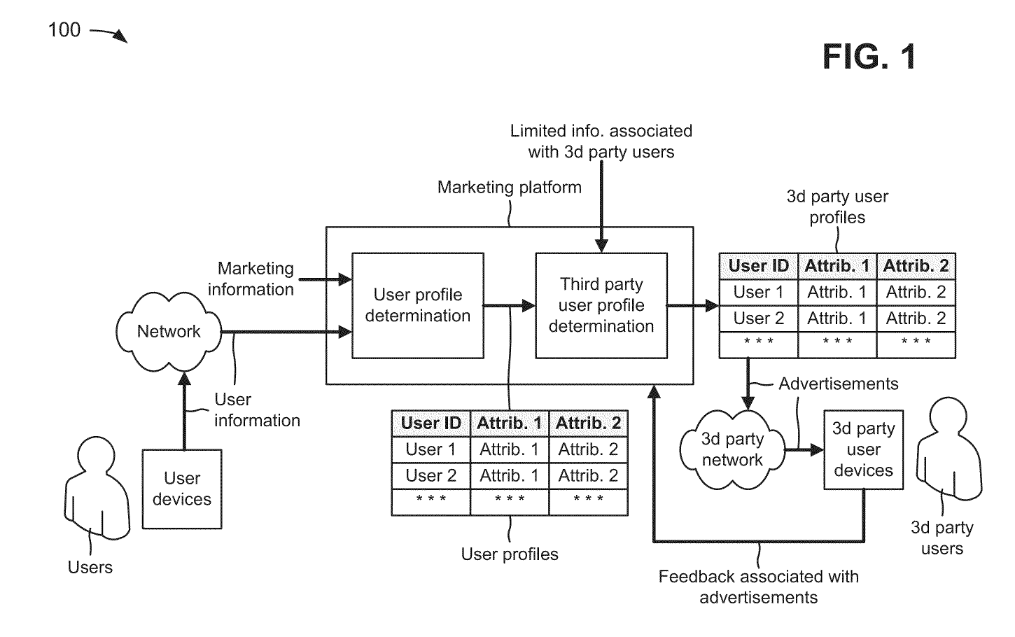

FIG. 1 is a diagram of an overview of an example implementation 100 described herein. In example implementation 100, assume that a marketing platform is associated with a network that supports multiple user devices associated with users. The marketing platform may receive user information (e.g., via the network) and marketing information. The user information may be generated by the multiple user devices, and may include information associated with the user devices and the users, network information, etc. The user information may be stored in the user devices and/or in a network resource (e.g., a server device), and provided to the marketing platform. The marketing information may include information associated with products and/or services offered by vendors and to be marketed to the users, advertisements for the products and/or the services, etc.

The marketing platform may include a user profile determination component and a third party user profile determination component. The user profile determination component may create user profiles for the users based on the user information and the marketing information. For example, the user profile determination component may create a user profile, for a particular user, that includes a user identifier (ID) (e.g., a unique user name, a user identification number, etc.) and multiple attributes associated with the particular user (e.g., demographic information, location information, time information, user device information, etc.). The user profile determination component may provide the user profiles to the third party user profile determination component.

The third party user profile determination component may determine third party user profiles based on the user profiles and based on a limited amount of information that is known by the third party user profile determination component about the third party users. The limited information associated with the third party users may include less information (e.g., attributes) than information provided by the user profiles. The third party user profile determination component may enhance (e.g., via machine learning) the limited information, with information associated with the user profiles, to create the third party user profiles. The third party user profiles may include user profiles (e.g., user IDs and multiple attributes) associated with third party users and third party user devices of a third party network. The third party network, the third party user devices, and the third party users may not be associated with the marketing platform, the network, the user devices, and/or the users.

The third party user profile determination component may determine advertisements to provide to the third party users based on the third party user profiles and/or the marketing information. As further shown in FIG. 1, the third party user profile determination component may cause the advertisements to be provided to the third party user devices and the third party users, via the third party network. The third party user profile determination component may provide the advertisements to the third party user devices in a variety of formats, such as via online advertisements (e.g., Internet advertisements), via mobile advertisements (e.g., advertisements sent to an application(s) executed by mobile devices), via short message service (SMS) advertisements, via a payment application (e.g., a credit card application, a debit card application, etc.), via a point of sale (POS) or checkout device (e.g., device at which a user makes a payment in exchange for products and/or services), via television advertisements, via email advertisements, etc.

The third party users may receive the advertisements (e.g., via the third party user devices), and may generate feedback (e.g., provision of the advertisements, purchase products/services associated with the advertisements, visit web pages relating to the advertisements, request that the advertisements not be provided in the future, etc.) associated with the advertisements. The third party user devices may provide the feedback to the marketing platform. The marketing platform may utilize the feedback to refine, improve, and/or modify the user profile determination component, the third party user profile determination component, and/or particular third party user profiles.

Systems and/or methods described herein may provide a marketing platform that determines third party user profiles based on user profiles associated with the marketing platform, and that provides advertisements to third party users associated with the third party user profiles. The systems and/or methods may ensure that personalized advertisements are delivered to the third party users at appropriate times and locations, regardless of the third party network associated with the third party users. By predicting information of interest to a third party user (e.g., whom little is known about) based on information associated with user profiles (e.g., whom a lot is known about), the systems and/or methods may more effectively serve advertisements, that are likely to be of interest to the third party user. The systems and/or methods may enable vendors to allocate marketing budgets so that the advertisements are provided to the third party users in a most productive manner.

As used herein, the term user is intended to be broadly interpreted to include a user device, or a user of a user device. The term vendor, as used herein, is intended to be broadly interpreted to include a business, an organization, a government agency, a vendor device, a user of a vendor device, etc.

A product, as the term is used herein, is to be broadly interpreted to include anything that may be marketed or sold as a commodity or a good. For example, a product may include bread, coffee, bottled water, milk, soft drinks, pet food, beer, fuel, meat, fruit, automobiles, clothing, content, etc. The term content, as used herein, is to be broadly interpreted to include video, audio, images, text, software downloads, and/or combinations of video, audio, images, text, and software downloads.

A service, as the term is used herein, is to be broadly interpreted to include any act or variety of work done for others (e.g., for compensation). For example, a service may include a repair service (e.g., for a product), a warranty (e.g., for a product), a telecommunication service (e.g., a telephone service, an Internet service, a network service, a radio service, a television service, a video service, etc.), an automobile service (e.g., for selling automobiles), a food service (e.g., a restaurant), a banking service, a lodging service (e.g., a hotel), etc.

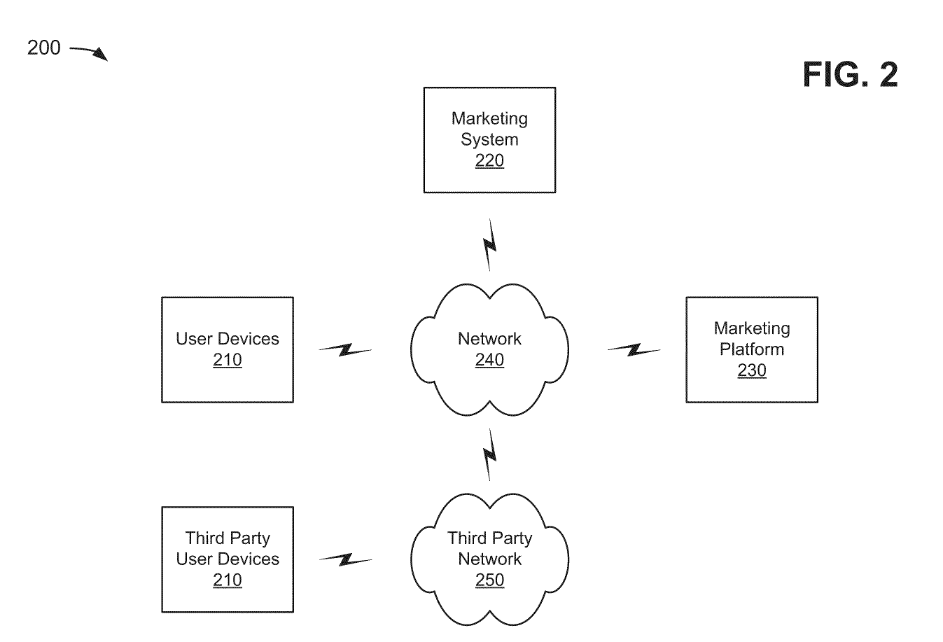

FIG. 2 is a diagram of an example environment 200 in which systems and/or methods described herein may be implemented. As illustrated, environment 200 may include user devices 210, third party user devices 210, a marketing system 220, a marketing platform 230, a network 240, and a third party network 250. Devices/networks of environment 200 may interconnect via wired connections, wireless connections, or a combination of wired and wireless connections.

User device 210 may include a device that is capable of communicating over network 240 with marketing system 220 and/or marketing platform 230. In some implementations, user device 210 may include a radiotelephone; a personal communications services (PCS) terminal that may combine, for example, a cellular radiotelephone with data processing and data communications capabilities; a smart phone; a configured television; a personal digital assistant (PDA) that can include a radiotelephone, a pager, Internet/intranet access, etc.; a laptop computer; a tablet computer; a global positioning system (GPS) device; a gaming device; a set-top box (STB); or another type of computation and communication device. In some implementations, user device 210 may be associated with a service provider that manages and/or operates network 240, such as, for example, a telecommunication service provider, a television service provider, an Internet service provider, a wireless service provider, etc.

Third party user device 210 may include a device that is capable of communicating over third party network 250 with marketing system 220 and/or marketing platform 230. For example, third party user device 210 may include a radiotelephone, a PCS terminal, a smart phone; a PDA, a configured television, a laptop computer, a tablet computer, a GPS device, a gaming device, a STB, or another type of computation and communication device. In some implementations, third party user device 210 may be associated with a service provider that manages and/or operates third party network 250, such as, for example, a telecommunication service provider, a television service provider, an Internet service provider, a wireless service provider, etc.

Marketing system 220 may include one or more personal computers, one or more workstation computers, one or more server devices, one or more virtual machines (VMs) provided in a cloud computing network, and/or one or more other types of computation and communication devices. In some implementations, marketing system 220 may be associated with one or more vendors or other entities that provide marketing services for the vendors. In some implementations, marketing system 220 may enable vendors to generate marketing information, and to provide the marketing information to user devices 210, third party user devices 210, and/or marketing platform 230. The marketing information may include information associated with products and/or services offered by the vendors and to be marketed to the users; advertisements for the products and/or the services offered by the vendors; marketing campaign information (e.g., a campaign for a particular product and/or service, a marketing budget for the campaign, timing associated with the campaign, etc.); interactions (e.g., transactions, creation of user accounts with the vendors, creation of user profiles with the vendors, etc.) between the vendors and the users (e.g., between marketing system 220 and user devices 210); etc.

Marketing platform 230 may include one or more personal computers, one or more workstation computers, one or more server devices, one or more VMs provided in a cloud computing network, and/or one or more other types of computation and communication devices. In some implementations, marketing platform 230 may be associated with a service provider that manages and/or operates network 240, such as, for example, a telecommunication service provider, a television service provider, an Internet service provider, a wireless service provider, etc.

In some implementations, marketing platform 230 may receive user information associated with users of network 240, and may receive marketing information associated with products and/or services offered by vendors and/or marketed by marketing system 220. Marketing platform 230 may create user profiles based on the user information and/or the marketing information, and may determine third party user profiles for third party users of third party network 250 based on the user profiles and based on limited information associated with the third party users. Marketing platform 230 may determine advertisements to provide to the third party users based on the third party user profiles and the marketing information, and may cause the advertisements to be provided to the third party users via third party network 250. Marketing platform 230 may receive feedback associated with the advertisements from third party user devices 210 associated with the third party users, and may utilize the feedback to refine the determination of the third party user profiles.

Network 240 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks. In some implementations, network 240 may be associated with a service provider (e.g., and be referred to as a service provider network) that manages and/or operates network 240, such as, for example, a telecommunication service provider, a television service provider, an Internet service provider, a wireless service provider, etc.

In some implementations, the cellular network may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN), and may include one or more base stations. The EPC network may include an all-Internet protocol (IP) packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN) RAN. The IMS network may include an architectural framework or network (e.g., a telecommunications network) for delivering IP multimedia services. The PDN may include a communications network that is based on packet switching. In some implementations, the cellular network may provide location information (e.g., latitude and longitude coordinates) associated with user devices 210. For example, the cellular network may determine a location of user device 210 based on triangulation of signals, generated by user device 210 and received by multiple base stations, with prior knowledge of the base stations.

In some implementations, the satellite network may include a space-based satellite navigation system (e.g., a global positioning system (GPS)) that provides location and/or time information in all weather conditions, anywhere on or near the Earth where there is an unobstructed line of sight to four or more satellites (e.g., GPS satellites). In some implementations, the satellite network may provide location information (e.g., GPS coordinates) associated with user devices 210, enable communication with user devices 210, etc.

Third party network 250 may include a network, such as a LAN, a WAN, a MAN, a telephone network, such as the PSTN or a cellular network, an intranet, the Internet, a fiber optic network, a satellite network, a cloud computing network, or a combination of networks. In some implementations, third party network 250 may be managed and/or operated by a service provider (e.g., and be referred to as a third party service provider network), such as, for example, a telecommunication service provider, a television service provider, an Internet service provider, a wireless service provider, etc.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

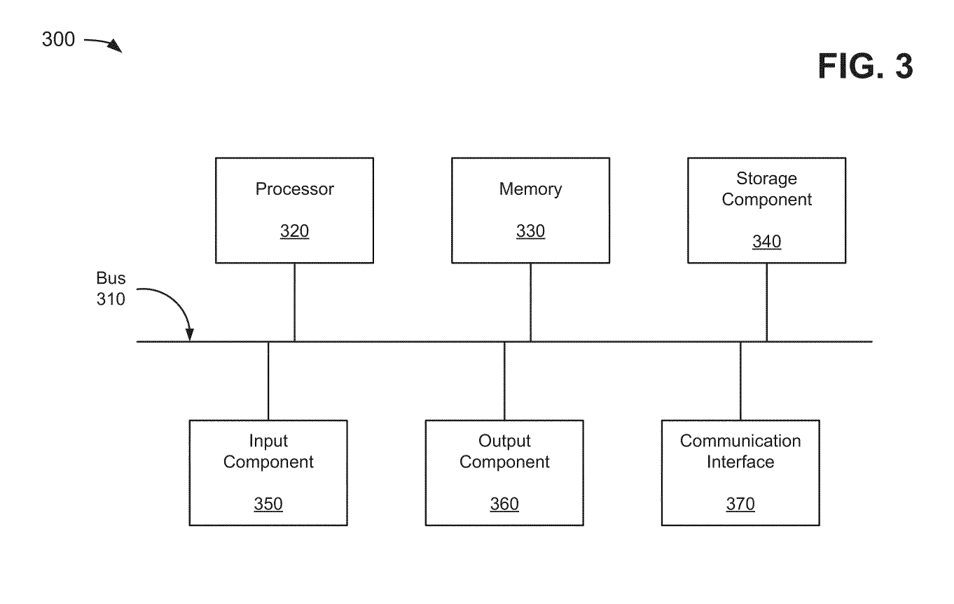

FIG. 3 is a diagram of example components of a device 300 that may correspond to one or more of the devices of environment 200. In some implementations, each of the devices of environment 200 may include one or more devices 300 or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

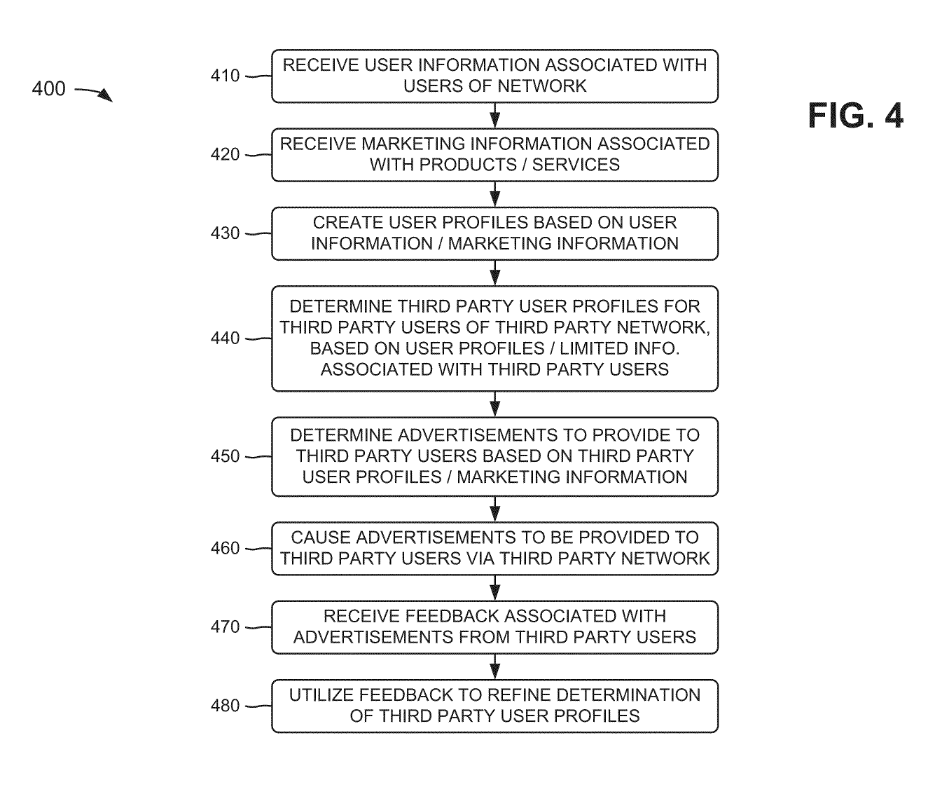

FIG. 4 is a flow chart of an example process 400 for determining advertisements for third party users of a third party network. In some implementations, one or more process blocks of FIG. 4 may be performed by marketing platform 230. In some implementations, one or more process blocks of FIG. 4 may be performed by another device or a group of devices separate from or including marketing platform 230, such as user device 210, third party user device 210, and/or marketing system 220.

As shown in FIG. 4, process 400 may include receiving user information associated with users of a network (block 410). For example, marketing platform 230 may receive, from user devices 210, user information associated with users of network 240. In some implementations, the user information may include information associated with user devices 210 (e.g., types of user devices 210, model numbers of user devices 210, etc.); information associated with the users of user devices 210 (e.g., account information, demographic information, etc.); network information (e.g., information associated with network resources of network 240 utilized by user devices 210); usage information associated with network 240 by user devices 210; content accessed by user devices 210; transactions associated with user devices 210; clickstream information associated with user devices 210; location information associated with user devices 210; time information associated with user devices 210; etc.

The clickstream information may include information associated with portions of user interfaces that users select (e.g., or click on) while web browsing (e.g., accessing content) or while using a software application. The location information may include information associated with locations (e.g., global positioning system (GPS) coordinates, cellular triangulation locations, etc.) of user devices 210 when content is accessed by user devices 210. In some implementations, the location information may include information associated with a current location of user device 210, proximity of user device 210 to something (e.g., another user device 210, a store, etc.), travel patterns of user device 210 (e.g., stops at a particular coffee shop on his way to work each day, drives home from work at 6:00 PM, a route traveled by user device 210, etc.), travel information (e.g., relating to an upcoming trip), a current location of another user device 210 (e.g., of a family member), etc. The time information may include information associated with times when user devices 210 access the content (e.g., dates and times when the content is accessed, an amount of time the user devices are performing online activities, such as browsing, etc.). In some implementations, the time information may include information associated with holidays, birthday(s), meetings, time of day, time of a week, etc.

In some implementations, user devices 210 may receive user information from users when the users register user devices 210 for a service (e.g., a telephone service, an Internet service, a television service, etc.) and may include registration information, such as names, home addresses, contact information, account types, demographic information, gender information, etc. In some implementations, marketing platform 230 may continuously receive the user information from user devices 210 and/or network 240. In some implementations, marketing platform 230 may periodically (e.g., hourly, daily, weekly, etc.) receive the user information from user devices 210 and/or network 240. In some implementations, the user information may be stored in user devices 210 and/or in a network resource (e.g., a server device) of network 240, and continuously and/or periodically provided to marketing platform 230.

In some implementations, user device 210 may include an application that monitors, with the user's approval, actions taken in relation to user device 210. The application, on user device 210, may continuously transmit the monitored information (e.g., the user information and information identifying the user) to marketing platform 230, or may cause user device 210 to store the monitored information and provide the monitored information when requested by marketing platform 230 (e.g., during times when traffic of network 240 is low).

As further shown in FIG. 4, process 400 may include receiving marketing information associated with products and/or services (block 420). For example, marketing platform 230 may receive marketing information from marketing system 220. The marketing information may include information associated with products and/or services offered by vendors and to be marketed to the users; advertisements for the products and/or the services offered by the vendors; marketing campaign information (e.g., a campaign for products and/or services, a marketing budget for the campaign, timing associated with the campaign, etc.); user information received by the vendors via interactions between the vendors and the users; etc.

As further shown in FIG. 4, process 400 may include creating user profiles based on the user information and/or the marketing information (block 430). For example, marketing platform 230 may create user profiles, for the users, based on the user information and/or the marketing information. In some implementations, a user profile, for a particular user, may include a user identifier (ID) (e.g., a unique user name, a user identification number, etc.) and multiple attributes associated with the particular user (e.g., demographic information, location information, time information, user device information, interests, behavior, advertisements received, purchases made, etc.). For example, assume that a particular user (e.g., Susan) utilizes a mobile user device 210 (e.g., a smart phone), and that location information associated with the smart phone indicates that Susan is at a particular location (e.g., at a beach) every weekend. Further, assume that Susan utilizes the smart phone to receive advertisements associated with restaurants at the beach. In such an example, marketing platform 230 may create a user profile for Susan that includes information indicating interests of Susan (e.g., Susan is interested in the beach), behavior of Susan (e.g., Susan travels to the beach), advertisements received by Susan (e.g., Susan receives beach restaurant advertisements via the mobile user device 210), etc.

In another example, assume that a particular user (e.g., Fred) utilizes a particular user device 210 (e.g., a gaming device) to play online games, and that Fred utilizes the gaming device to shop for online games. Further, assume that Fred utilizes the gaming device to receive advertisements associated with new online games when Fred shops for online games. In such an example, marketing platform 230 may create a user profile for Fred that includes information indicating interests of Fred (e.g., Fred is interested in online games), behavior of Fred (e.g., Fred shops online for games), advertisements received by Fred (e.g., Fred receives new online games advertisements via the gaming device), etc.

In still another example, assume that a particular user (e.g., Jane) plays golf, and utilizes a mobile user device 210 (e.g., a tablet) when playing golf and to purchase golf equipment (e.g., golf clubs, golf balls, etc.). Further, assume that Jane utilizes the tablet to receive advertisements associated with golf lessons when Jane purchases the golf equipment. In such an example, marketing platform 230 may create a user profile for Jane that includes information indicating interests of Jane (e.g., Jane is interested in golf), behavior of Jane (e.g., Jane purchases golf equipment via the mobile user device 210), advertisements received by Jane (e.g., Jane receives golf lesson advertisements via the mobile user device 210), etc.

As further shown in FIG. 4, process 400 may include determining third party user profiles for third party users of a third party network, based on the user profiles and information associated with the third party users (block 440). For example, marketing platform 230 may determine third party user profiles for third party users (e.g., associated with third party user devices 210) of third party network 250 based on the user profiles and based on limited information associated with the third party users. In some implementations, marketing platform 230 may receive the limited information associated with the third party users from marketing system 220, the service provider associated with third party network 250, and/or other sources (e.g., vendors). The limited information associated with the third party users may include user IDs and one or more attributes associated with the third party users. In some implementations, the limited information associated with the third party users may include less information (e.g., attributes) than information (e.g., attributes) associated with the user profiles. In some implementations, the limited information for a third party user may include a name, a home address (e.g., California versus Idaho), a gender (e.g., male versus female), purchased products/services, dates of the purchases, contact information (e.g., an email address), etc. In some implementations, marketing platform 230 may determine the third party user profiles based on an event, such as, for example, receiving the limited information associated with the third party users. For example, marketing platform 230 may determine the third party user profiles when a vendor provides information from a vendor database (e.g., relating to third party users) to marketing platform 230.

In some implementations, a third party user profile, for a particular third party user, may include a user ID and multiple attributes associated with the particular third party user (e.g., demographic information, location information, time information, user device information, interests, behavior, advertisements received, etc.). For example, assume that marketing platform 230 creates a user profile, for a user (e.g., Susan) of a mobile user device 210 (e.g., smart phone), that includes information indicating interests of Susan (e.g., Susan is interested in the beach), behavior of Susan (e.g., Susan travels to the beach), advertisements received by Susan (e.g., Susan receives beach restaurant advertisements via mobile user device 210), etc. Further, assume that the limited information associated with a third party user (e.g., John) indicates that John recently purchased a surf board. In such an example, marketing platform 230 may determine a third party user profile (e.g., for John) that is similar to Susan's user profile. For example, John's third party user profile may include information indicating interests (e.g., the beach), behavior (e.g., traveling to the beach), that John may be interested in receiving beach restaurant advertisements via his mobile user device 210, etc.

In some implementations, marketing platform 230 may utilize machine learning algorithms to determine the third party user profiles based on the user profiles. For example, assume that a user profile includes ten (10) attributes (e.g., interests, brands, behavior, products/services purchased, information identifying vendors from which the purchases were made, etc.), and that limited information associated with a third party user includes four (4) of the ten (10) attributes. In such an example, marketing platform 230 may utilize the machine learning algorithms to determine the remaining six (6) attributes of the user profile. Marketing platform 230 may then combine the remaining six (6) attributes with the four (4) attributes from the limited information to predict a third party user profile (e.g., for the third party user) with ten (10) attributes. In some implementations, the user profiles may include differing amounts of information (e.g., some user profiles may include more or less attributes than other user profiles). Therefore, the third party profiles may include a number of attributes greater than a number of attributes (e.g., provided by the limited information) but less than the number of attributes provided in the user profiles. In some implementations, marketing platform 230 may attempt to predict, for the third party user profiles, all of the attributes provided in the user profiles, but may only include those attributes with particular probabilities of matching the third party user profiles (e.g., probabilities greater than a particular threshold).

In some implementations, the machine learning algorithms may include the construction and study of systems that can learn from information, such as the user profiles. The machine learning algorithms may include, for example, decision tree learning, association rule learning, artificial neural networks, inductive logic programming, support vector machines, clustering, Bayesian networks, representation learning, similarity learning, sparse dictionary learning, etc.

Decision tree learning may utilize a decision tree as a predictive model that maps observations about an item (e.g., a user profile) to conclusions about the item's target (e.g., a third party user profile). Association rule learning may include a method for discovering relations between variables (e.g., the user profiles and the third party user profiles). An artificial neural network may include non-linear statistical data modeling tools, and may model complex relationships between inputs (e.g., the user profiles) and outputs (e.g., the third party user profiles), to find patterns in data, or to capture statistical structure in an unknown joint probability distribution between observed variables. Inductive logic programming may utilize logic programming as a uniform representation for input examples, background knowledge, and/or hypotheses. Given known background knowledge and a set of examples represented as a logical database of facts (e.g., the user profiles), inductive logic programming may derive a hypothesized logic program that includes positive examples (e.g., the third party user profiles). A support vector machine may include a set of related supervised learning methods used for classification and regression. Given a set of training examples (e.g., the user profiles), each marked as belonging to one of two categories, a support vector machine may create a model that predicts whether a new example (e.g., the third party user profiles) falls into one category or the other.

Clustering may include an assignment of a set of observations (e.g., the user profiles) into subsets or clusters so that observations within a same cluster may be similar according to a particular criterion, while observations within different clusters may be dissimilar. In some implementations, clustering may include one or more of the following metrics: Euclidean distance, squared Euclidean distance, Manhattan distance, maximum distance, Mahalanobis distance, cosine similarity, etc.

A Bayesian network may include a probabilistic graphical model that represents a set of random variables and conditional independencies via a directed acyclic graph (DAG). For example, the Bayesian network may represent probabilistic relationships between the user profiles and the third party user profiles.

Representation learning may attempt to preserve information (e.g., the user profiles), but may transform the information in a way that makes the information useful. For example, representation learning may perform a pre-processing step before performing classification or predictions, which may permit reconstruction of unknown information. Similarity learning may utilize pairs of examples that are considered similar and pairs of less similar examples, and may determine a similarity function (e.g., a distance metric function) that can predict if new examples are similar. In sparse dictionary learning, data may be represented as a linear combination of basis functions, and coefficients may be assumed to be sparse.

In some implementations, marketing platform 230 may assign weights (e.g., values, percentages, etc.) to different information (e.g., attributes) associated with the user profiles, such as interests (e.g., sports, weather, news, etc.) associated with users, behavior (e.g., watch sports on television, shop online, etc.) associated with the users, types of advertisements (e.g., television, online, print, email, etc.) received by the users, etc. In some implementations, marketing platform 230 may calculate a score for each of the user profiles based on the assigned weights. For example, assume that marketing platform 230 assigns a weight of 0.3 to interests associated with the users, a weight of 0.9 to behavior associated with the users, and a weight of 0.1 to the types of advertisements received by the users. Further, marketing platform 230 may create three user profiles (e.g., X, Y, and Z) based on the user information and/or the marketing information, and may calculate a score of 0.8 for user profile X, a score of 0.6 for user profile Y, and a score of 0.7 for user profile Z. In some implementations, marketing platform 230 may utilize known attributes about a third party user to predict other attributes for the third party user. If a probability of an attribute being associated with the third party user is greater than particular threshold, marketing platform 230 may include the attribute in a third party user profile for the third party user. For example, assume that 100% of the users that purchase surf boards (e.g., from the user profiles) are interested in the beach. If a third party user purchases a surf board, marketing platform 230 may assume with a high probability that the third party user is interested in the beach (e.g., based on the user profiles).

As further shown in FIG. 4, process 400 may include determining advertisements to provide to the third party users based on the third party user profiles and the marketing information (block 450). For example, marketing platform 230 may identify advertisements in the marketing information. In some implementations, marketing platform 230 may identify, in the marketing information, advertisements for products and/or services associated with vendors. For example, assume that the marketing information includes information associated with a vendor (e.g., a sporting goods store), products offered by the vendor (e.g., sporting goods), and an online advertisement created by or for the sporting goods store. In such an example, marketing platform 230 may identify the online advertisement in the marketing information.

In some implementations, marketing platform 230 may determine advertisements (e.g., identified in the marketing information) to provide to the third party users (e.g., third party user devices 210) based on the determined third party user profiles. In some implementations, marketing platform 230 may calculate scores for the determined advertisements based on the marketing information. In some implementations, marketing platform 230 may assign weights (e.g., values, percentages, etc.) to different factors (e.g., of the marketing information) to be used to determine scores for the advertisements, such as whether the advertisements are received by users, whether users buy products/services based on the advertisements, a number of users that receive the advertisements, types of advertisements (e.g., online, print, email, etc.), etc. In some implementations, marketing platform 230 may calculate a score for each of the advertisements based on the factors and the assigned weights. For example, assume that marketing platform 230 assigns a weight of 0.3 to whether the advertisements are received by users, a weight of 0.9 to whether users buy products/services based on the advertisements, a weight of 0.4 to the number of users that receive the advertisements, and a weight of 0.1 to the types of advertisements. Further, marketing platform 230 may identify three advertisements (e.g., A, B, and C) in the marketing information, and may calculate a score of 0.8 for advertisement A, a score of 0.6 for advertisement B, and a score of 0.7 for advertisement C.

In some implementations, marketing platform 230 may determine one or more particular advertisements to provide to a particular third party user based on the products/services associated with the particular advertisements and based on the third party user profile associated with the particular third party user. For example, assume that marketing platform 230 identifies a particular third party user that is interested in a particular car, and identifies three advertisements (e.g., A, B, and C) for the particular car in the marketing information. Further, assume that marketing platform 230 calculates a score of 0.2 for advertisement A, a score of 0.3 for advertisement B, and a score of 0.7 for advertisement C based on the factors and the assigned weights associated with the marketing information. In such an example, marketing platform 230 may identify advertisements A-C as advertisements to provide to the particular third party user, may identify only advertisement C to be provided to the particular third party user since advertisement C has the greatest score, etc. In some implementations, marketing platform 230 may identify, for providing to the third party users, all of the advertisements, advertisements with scores greater than a particular threshold, a top percentage of advertisements based on the scores, etc.

In some implementations, marketing platform 230 may identify, for providing to a particular third party user, an advertisement with a greatest score for the particular third party user. For example, assume that marketing platform 230 identifies three advertisements A-C for a particular third party user, and calculates a score of 0.4 for advertisement A, a score of 0.7 for advertisement B, and a score of 0.5 for advertisement C. In such an example, marketing platform 230 may identify advertisement B as an advertisement to be provided to the particular third party user based since advertisement B has the greatest score.

In some implementations, marketing platform 230 may identify an advertisement with a lowest score for the particular third party user. For example, assume that marketing platform 230 identifies three advertisements A-C for a particular third party user, and calculates a score of 0.4 for advertisement A, a score of 0.7 for advertisement B, and a score of 0.5 for advertisement C. In such an example, marketing platform 230 may identify advertisement A as an advertisement to be provided to the particular third party user since advertisement A has the lowest score.

As further shown in FIG. 4, process 400 may include causing the advertisements to be provided to the third party users via the third party network (block 460). For example, marketing platform 230 may cause the advertisements to be provided to the third party users (e.g., to third party user devices 210) via third party network 250. In some implementations, marketing platform 230 may provide the advertisements directly to third party user devices 210, via third party network 250. For example, assume that marketing platform 230 determines that an advertisement for an antique furniture store is to be provided to third party user devices 210 associated with third party users interested in antique furniture, via an email message. In such an example, marketing platform 230 may generate the email message, with the advertisement, and may provide the email message directly to third party user devices 210 associated with the third party users interested in antique furniture. In some implementations, marketing platform 230 may cause the advertisements to be provided to the third party users in response to an event. For example, assume that marketing platform 230 determines that an advertisement for a free drink at a restaurant is to be provided, to third party user device 210 associated with a third party user who frequently eats at the restaurant, when the third party user is located close to the restaurant (e.g., but not when the third party user is located more than a particular number of miles from the restaurant).

In some implementations, marketing platform 230 may instruct marketing system 220 to provide the advertisements to third party user devices 210 associated with the third party users. For example, assume that marketing platform 230 determines that an advertisement for a free cup of coffee at a coffee shop is to be provided, to third party user devices 210 associated with third party users who frequently drink coffee at the coffee shop, via a SMS message. In such an example, marketing platform 230 may instruct marketing system 220 to generate the SMS message, with the advertisement for the free cup of coffee. Marketing system 220 may provide the SMS message to third party user devices 210 associated with the third party users who frequently drink coffee at the coffee shop.

In some implementations, marketing platform 230 may cause an advertisement to be provided to a user and a third party user when a user profile for the user is utilized by marketing platform 230 to determine a third party user profile for the third party user. For example, assume that marketing platform 230 creates a user profile for a user (e.g., Jane) that is interested in sports cars, and determines a third party user profile (e.g., for a third party user, Sue) based on Jane's user profile and based on limited information associated with Sue (e.g., indicating that Sue owns a sports car). In such an example, marketing platform 230 may cause an advertisement for a sports car to be provided to user device 210 associated with Jane (e.g., via network 240) and third party user device 210 associated with Sue (e.g., via third party network 250).

As further shown in FIG. 4, process 400 may include receiving feedback associated with the advertisements from the third party users (block 470). For example, marketing platform 230 may receive feedback associated with the advertisements from third party user devices 210 associated with the third party users. In some implementations, marketing platform 230 may receive the feedback directly from third party user devices 210 associated with the third party users. In some implementations, third party user devices 210 associated with the third party users may provide the feedback to marketing system 220 (or another device), and marketing system 220 (or the other device) may provide the feedback to marketing platform 230. In some implementations, the feedback may include information indicating whether the third party users were provided the advertisements, purchased products/services associated with the advertisements, visited web pages relating to the advertisements, requested that the advertisements not be provided in the future, etc.

For example, assume that marketing platform 230 causes an advertisement for a fishing rod to be provided to third party user devices 210 associate with three third party users (e.g., A, B, and C). Further, assume that user A utilizes a link from the advertisement to purchase the fishing rod online, that user B receives the advertisement and visits a web page but does not purchase the fishing rod, and that user C requests that such emails not be provided in the future. Information associated with the actions of users A-C may be provided as feedback to marketing platform 230, where the feedback for user A may be considered the best feedback, the feedback for user B may be considered the next best feedback, and the feedback for user C may be considered the worst feedback.

As further shown in FIG. 4, process 400 may include utilizing the feedback to refine the determination of the third party user profiles (block 480). For example, marketing platform 230 may utilize the feedback to refine the determination of the third party user profiles based on the user profiles and the limited information associated with the third party users. In some implementations, marketing platform 230 may utilize the feedback to modify the machine learning algorithms used to determine the third party user profiles, inputs associated with the machine learning algorithms, etc. In some implementations, marketing platform 230 may modify a particular third party user profile associated with a third party user from which the feedback is received.

For example, assume that marketing platform 230 creates a user profile for a user (e.g., Bob) that is interested in computers, and determines a third party user profile (e.g., for a third party user, Ron) based on Bob's user profile and based on limited information associated with Ron (e.g., indicating that Ron is interested in computers). Marketing platform 230 may cause an advertisement for a computer to be provided (e.g., via an email message) to user device 210 associated with Bob (e.g., via network 240) and third party user device 210 associated with Ron (e.g., via third party network 250). However, Ron may not utilize email very often, and may open the email one week after Bob opens the email. This information may be utilized as feedback by marketing platform 230, and marketing platform 230 may modify the third party user profile to indicate that email advertising should be replaced with another form of advertising (e.g., SMS advertising).

In some implementations, marketing platform 230 may utilize the feedback to improve other functions provided by marketing platform 230, such as, for example, creating the user profiles, determining the advertisements to provide to the third party users, etc.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

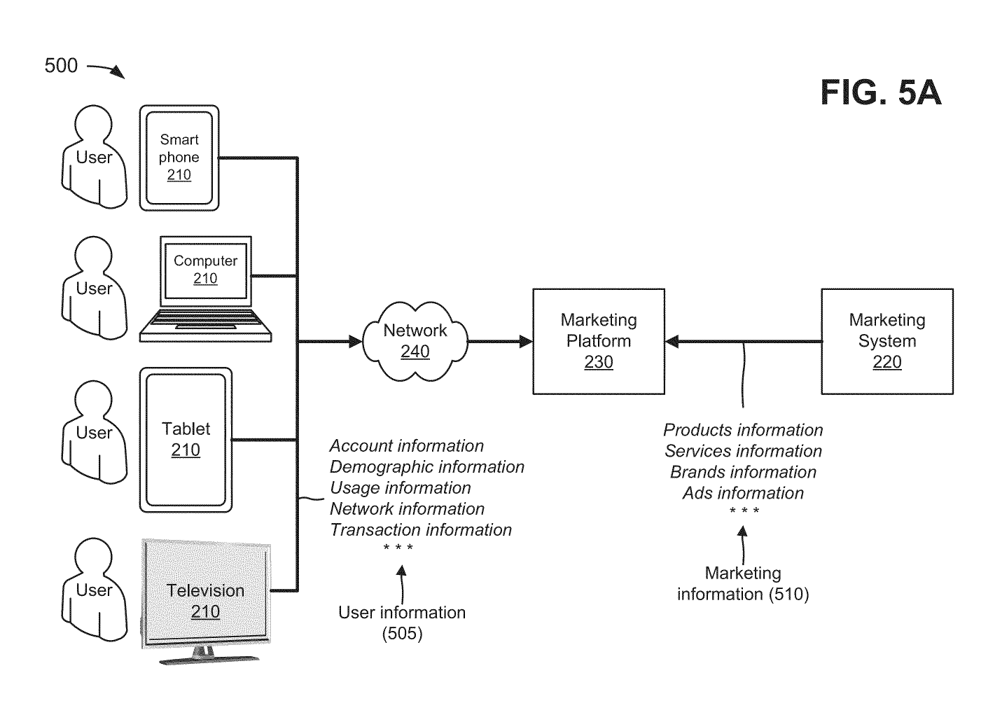

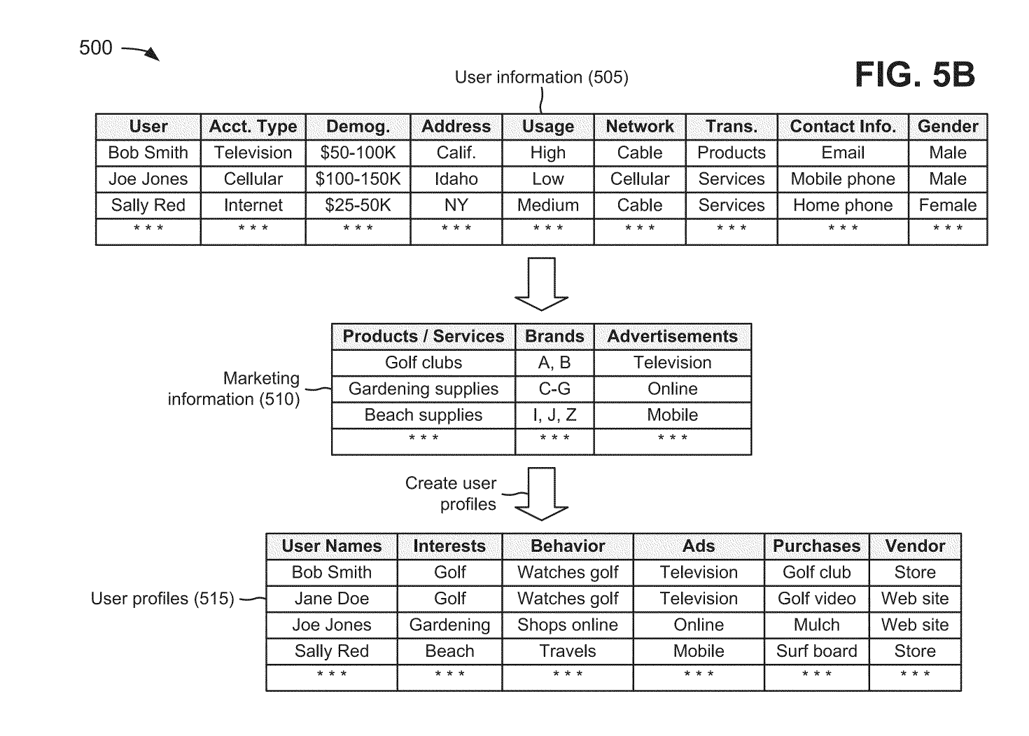

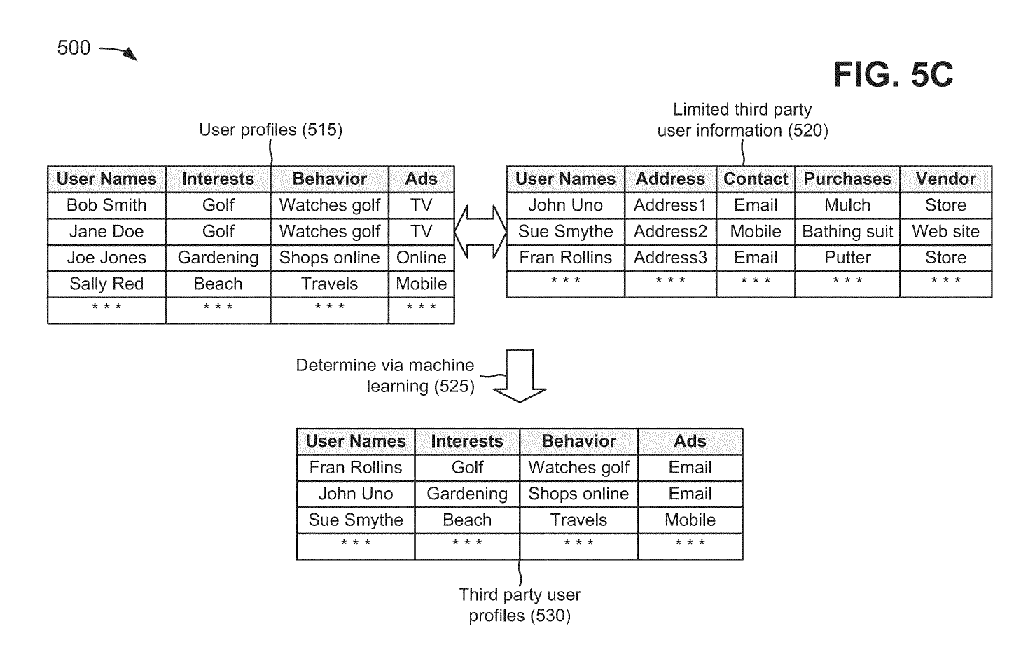

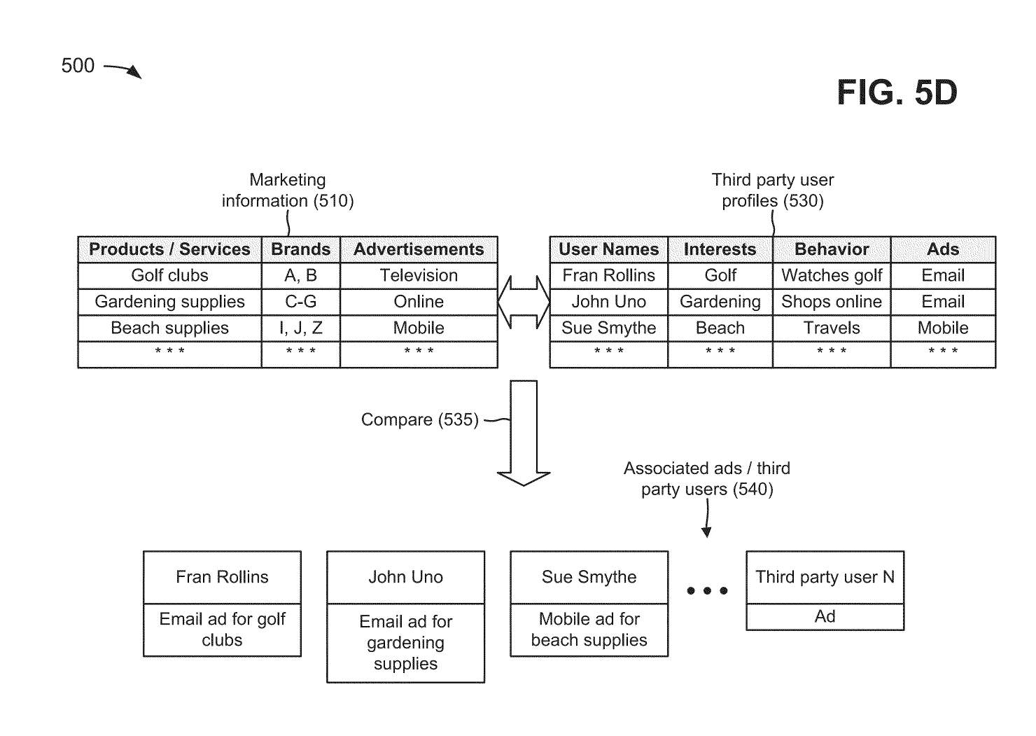

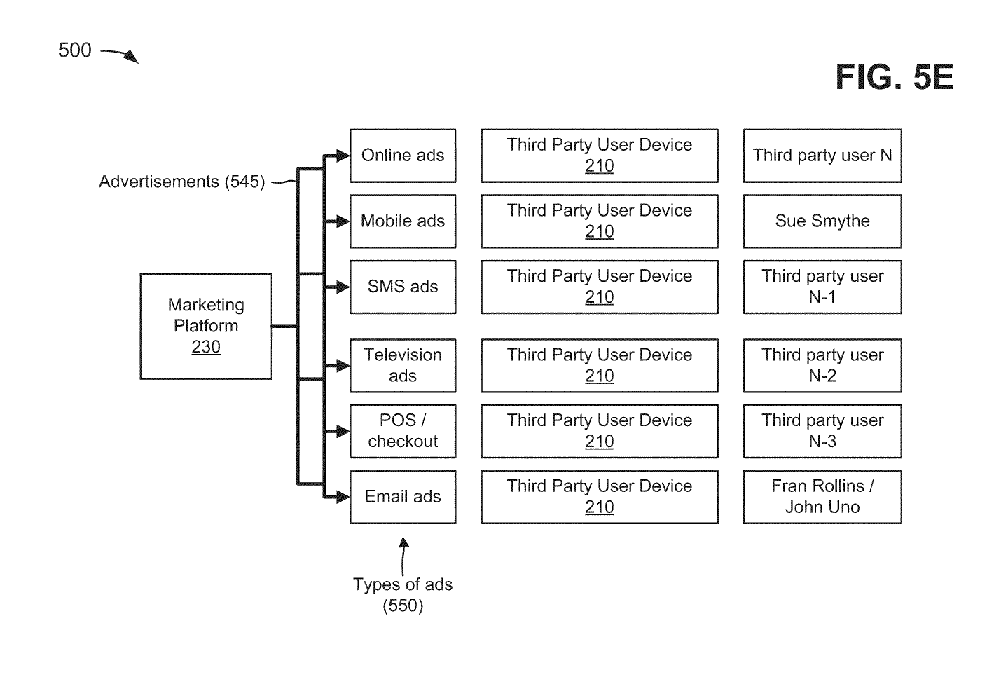

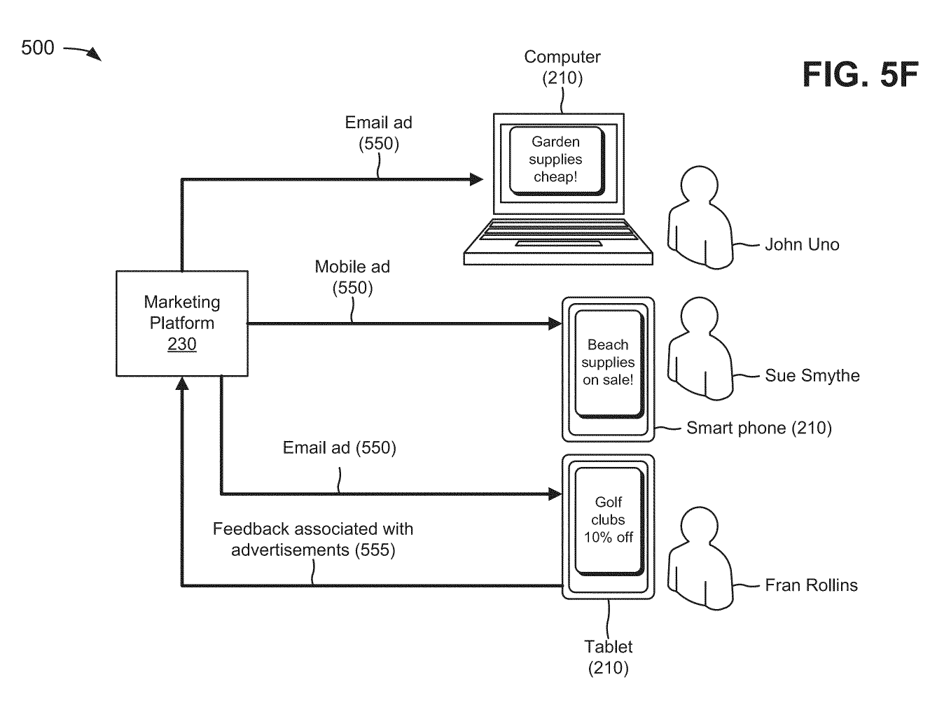

FIGS. 5A-5F are diagrams of an example 500 relating to example process 400 shown in FIG. 4. With reference to FIG. 5A, assume that users are associated with a variety of user devices 210 (e.g., smart phones, computers, tablets, televisions, etc.) that provide user information 505. User information 505 may include information associated with user devices 210 and the users (e.g., account information, demographic information, etc.); network information (e.g., information associated with network resources of network 240 utilized by user devices 210); network usage information associated with user devices 210; content accessed by user devices 210; transactions associated with user devices 210; clickstream information associated with user devices 210; location information associated with user devices 210; time information associated with user devices 210; etc. User devices 210 may provide user information 505 to marketing platform 230, and marketing platform 230 may receive user information 505.

As further shown in FIG. 5A, marketing system 220 may provide marketing information 510 that includes information associated with products and/or services offered by vendors and to be marketed to the users; advertisements for the products and/or the services offered by the vendors; brands information; marketing campaign information; user information 505 received by the vendors via interactions between the vendors and the users; etc. Marketing system 220 may provide marketing information 510 to marketing platform 230, and marketing platform 230 may receive marketing information 510.

As shown in FIG. 5B, marketing platform 230 may store user information 505 in a data structure (e.g., a tree, a table, a list, a database, etc.) that includes a user field, an account type field, a demographic field, an address field, a usage field, a network field, a transaction field, a contact information field, a gender field, and multiple entries associated with the fields. The user field may include information identifying the users of user devices 210, such as, for example, names, user identifiers, user account numbers, etc. The account type field may include information identifying types of accounts associated with the users, such as, for example, a television service account, a cellular service account, an Internet service account, etc. The demographic field may include information identifying demographics of the users, such as, for example, income levels of the users, education levels of the users, age, race, etc. The address field may include information identifying home addresses of the users. The usage field may include information identifying network usage by the users, such as, for example, high network usage, medium network usage, low network usage, bandwidth utilization, etc. The transaction field may include information identifying transactions performed by the users with user devices 210, such as, for example, transactions for products, services, etc. The contact information field may include information identifying contact information (e.g., email addresses, mobile phone numbers, home phone numbers, etc.) for the users. The gender field may include information identifying genders (e.g., male versus female) of the users.

As further shown in FIG. 5B, marketing platform 230 may store marketing information 510 in a data structure that includes a products/services field, a brands field, an advertisements field, and multiple entries associated with the fields. The products/services field may include information identifying products/services that vendors wish to sell to users, such as, for example, golf clubs, gardening supplies, beach supplies, etc. The brands field may include information identifying brands associated with the products/services, such as, for example, brands A and B for the golf clubs, brands C-G for the gardening supplies, brands I, J, and Z for the beach supplies, etc. The advertisements field may include information identifying advertisements associated with the products/services, such as, for example, television advertisements for the golf clubs, online advertisements for the gardening supplies, mobile advertisements for the beach supplies, etc. that may be shown on television (e.g., via a STB), via an email message, via a SMS message, etc.

Marketing platform 230 may generate user profiles 515 based on user information 505 and marketing information 510, as further shown in FIG. 5B. A particular user profile 515, for a particular user, may include a user identifier and multiple attributes associated with the particular user (e.g., demographic information, location information, time information, user device information, interests, behavior, advertisements received, etc.). As shown, marketing platform 230 may store user profiles 515 in a data structure that includes a user names field, an interests field, a behavior field, an advertisements field, a purchases field, a vendor field, and multiple entries associated with the fields. The user names field may include information identifying the names of the users of user devices 210, such as, for example, Bob Smith, Jane Doe, Joe Jones, Sally Red, etc. The interests field may include information identifying interests of the users, such as, for example, golf, gardening, beach, etc. The behavior field may include information identifying behaviors of the users, such as, for example, watching golf, shopping online, traveling, etc.

The advertisements field may include information identifying advertisements provided to the users and a manner in which the advertisements are provided (e.g., via television, via online, via email, via SMS, etc.). For example, a particular user may receive a golf advertisement via email, a car advertisement via a SMS message, and a travel advertisement via television. The purchases field may include information identifying products/services purchased by the users, such as, for example, a golf club, a golf video, mulch, a surf board, etc. The vendor field may include information identifying vendors from which the products/services are purchased, such as, for example, a store for a vendor, a web site for a vendor, etc.

As shown in FIG. 5C, marketing platform 230 may receive limited third party user information 520 from marketing system 220, the service provider associated with third party network 250, and/or other sources (e.g., vendors), and may store limited third party user information 520 in a data structure that includes a user names field, an address field, a contact information field, a purchases field, a vendor field, and multiple entries associated with the fields. The user names field may include information identifying the names of the third party users of third party user devices 210, such as, for example, John Uno, Sue Smythe, Fran Rollins, etc. The address field may include information identifying home addresses of the third party users. The contact information field may include information identifying contact information (e.g., email addresses, mobile phone numbers, home phone numbers, etc.) for the third party users. The purchases field may include information identifying products/services purchased by the third party users, such as, for example, mulch, a bathing suit, a putter, etc. The vendor field may include information identifying vendors from which the products/services are purchased, such as, for example, a store for a vendor, a web site for a vendor, etc.

As further shown in FIG. 5C, marketing platform 230 may determine 525 (e.g., via machine learning) third party user profiles 530 based on user profiles 515 and limited third party user information 520. A particular third party user profile 530, for a particular third party user, may include a user identifier (e.g., Fran Rollins) and multiple attributes associated with the particular third party user (e.g., demographic information, location information, time information, user device information, interests, behavior, advertisements received, etc.). As shown, marketing platform 230 may store third party user profiles 530 in a data structure that includes a third party user names field, an interests field, a behavior field, an advertisements field, and multiple entries associated with the fields.

For example, marketing platform 230 may determine a third party user profile 530, for a third party user (e.g., Fran Rollins), based on user profiles 515 associated with Bob Smith and Jane Doe. Third party user profile 530 may include information associated with interests (e.g., golf), behavior (e.g., watches golf), and advertisements (e.g., email) for Fran Rollins. Marketing platform 230 may determine another third party user profile 530, for another third party user (e.g., John Uno), based on user profile 515 associated with Joe Jones. Third party user profile 530 may include information associated with interests (e.g., gardening), behavior (e.g., shops online), and advertisements (e.g., email) for John Uno. Marketing platform 230 may determine still another third party user profile 530, for still another third party user (e.g., Sue Smythe), based on user profile 515 associated with Sally Red. Third party user profile 530 may include information associated with interests (e.g., beach), behavior (e.g., travels), and advertisements (e.g., mobile) for Sue Smythe. Marketing platform 230 may continue this process until all of third party user profiles 530 are determined based on user profiles 515 and limited third party user information 520.

As shown in 5D, marketing platform 230 may compare 535 marketing information 510 and third party user profiles 530 in order to associate the advertisements and the third party users, as indicated by reference number 540. For example, marketing platform 230 may associate an email advertisement for golf clubs with a third party user (e.g., Fran Rollins), may associate an email advertisement for gardening supplies with another third party user (e.g., John Uno), may associate a mobile advertisement for beach supplies with still another third party user (e.g., Sue Smythe), etc.

As shown in FIG. 5E, marketing platform 230 may provide advertisements 545 to third party user devices 210 associated with the third party users. Marketing platform 530 may deliver advertisements 545 to the third party users in a variety of ways, as indicated by reference number 550 in FIG. 5E. For example, marketing platform 530 may deliver advertisements 545 as an online advertisement, as a mobile advertisement, as a SMS advertisement, as a television advertisement, on a receipt from a POS/checkout device, as an email advertisement, etc. As further shown in FIG. 5E, marketing platform 530 may deliver online advertisements 550 to third party user device 210 associated with third party user N, may deliver mobile advertisements 550 to third party user device 210 associated with Sue Smythe, may deliver SMS advertisements 550 to third party user device 210 associated with third party user N-1, may deliver television advertisements 550 to third party user device 210 associated with third party user N-2, may utilize a POS/checkout device for third party user N-3, and may deliver email advertisements 550 to third party user devices 210 associated with Fran Rollins and John Uno.

As shown in FIG. 5F, marketing platform 230 may deliver, to a computer 210 associated with John Uno, an email advertisement 550 that indicates that garden supplies are cheap. Marketing platform 230 may deliver, to a smart phone 210 associated with Sue Smythe, a mobile advertisement 550 that indicates that beach supplies are on sale. Marketing platform 230 may deliver, to a tablet 210 associated with Fran Rollins, an email advertisement 550 that indicates that golf clubs are 10% off. John Uno, Sue Smythe, and/or Fran Rollins may purchase products based on advertisements 550 or may do nothing based on advertisements 550. Such information may be provided as feedback 555 to marketing platform 230, as further shown in FIG. 5F. Marketing platform 230 may utilize feedback 555 to refine the determination of third party user profiles 530 based on user profiles 515.

As indicated above, FIGS. 5A-5F are provided merely as an example. Other examples are possible and may differ from what was described with regard to FIGS. 5A-5F.

Systems and/or methods described herein may provide a marketing platform that determines third party user profiles based on user profiles associated with the marketing platform, and that provides advertisements to third party users associated with the third party user profiles. The systems and/or methods may ensure that personalized advertisements are delivered to the third party users at appropriate times and locations, regardless of the third party network associated with the third party users. By predicting information of interest to a third party user (e.g., whom little is known about) based on information associated with user profiles (e.g., whom a lot is known about), the systems and/or methods may more effectively serve advertisements, that are likely to be of interest to the third party user. The systems and/or methods may enable vendors to allocate marketing budgets so that the advertisements are provided to the third party users in a most productive manner.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of hardware, firmware, and/or combinations of software and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, user information associated with users of user devices,
the user devices being associated with a service provider network;
receiving, by the device, marketing information associated with advertisements for at least one of products or services;
creating, by the device, user profiles, associated with the users, based on the user information;
receiving, by the device, information relating to a third party user,
the third party user being associated with a third party user device,
the third party user device being associated with a third party service provider network, and
the third party service provider network being different than the service provider network;
determining, by the device and based on the information relating to the third party user and the user profiles, a third party user profile for the third party user;
determining, by the device, a particular advertisement to provide to the third party user device based on the third party user profile and the marketing information; and
causing, by the device, the particular advertisement to be provided to the third party user device, via the third party service provider network.

2. The method of claim 1, further comprising:
receiving, from the third party user device, feedback associated with the particular advertisement; and
utilizing the feedback to refine the third party user profile.

3. The method of claim 1, further comprising:
receiving, from the third party user device, feedback associated with the particular advertisement; and
utilizing the feedback to refine the determination of a future advertisement to provide to the third party user device.

4. The method of claim 1, where determining the particular advertisement comprises:
assigning weights to the marketing information;
calculating scores for the advertisements based on the assigned weights; and
selecting the particular advertisement, from the advertisements, based on the calculated scores for the advertisements.

5. The method of claim 1, where determining the at least one third party user profile comprises:
utilizing the user profiles in a machine learning algorithm; and
solving the machine learning algorithm, based on the user profiles and the information relating to the third party user, to determine the third party user profile.

6. The method of claim 1, further comprising:
determining the third party user profile based on a particular user profile associated with a particular user,
the particular user being associated with a particular user device; and
causing the particular advertisement to be provided to:
the third party user device, via the third party service provider network, and
the particular user device, via the service provider network.

7. The method of claim 1, where the third party user profile includes:
a user identifier for the third party user,
a plurality of attributes based on the information relating to the third party user, and
a plurality of attributes based on one or more of the user profiles.

8. A system, comprising:
one or more devices to:
receive user information associated with users of user devices,
the user devices being associated with a service provider network;
receive marketing information associated with at least one of products or services,
the marketing information including information associated with advertisements for the at least one of products or services;
generate user profiles, associated with the users, based on the user information;
receive information relating to a third party user,
the third party user being associated with a third party user device,
the third party user device being associated with a third party service provider network, and
the third party service provider network being different than the service provider network;
determine, based on the information relating to the third party user and the user profiles, a third party user profile for the third party user;
determine a particular advertisement to provide to the third party user device based on the third party user profile and the marketing information; and
cause the particular advertisement to be provided to the third party user device, via the third party service provider network.

9. The system of claim 8, where, when determining the third party user profile, the one or more devices are further to:
determine the third party user profile based on one or more of the user profiles.

10. The system of claim 8, where the one or more devices are further to:
receive, from the third party user device, feedback associated with the particular advertisement; and
utilize the feedback to modify the third party user profile.

11. The system of claim 10, where the one or more devices are further to:
utilize the feedback to modify the determination of a future advertisement to provide to the third party user device.

12. The system of claim 8, where, when determining the particular advertisements, the one or more devices are further to:
assign weights to the marketing information;
calculate scores for the advertisements based on the assigned weights; and
select the particular advertisement, from the advertisements, based on the calculated scores for the advertisements.

13. The system of claim 8, where, when determining the third party user profiles, the one or more devices are further to:
utilize the user profiles in a machine learning algorithm; and
solve the machine learning algorithm, based on the user profiles and the information relating to the third party user, to determine the third party user profile.

14. The system of claim 8, where the third party user profile includes:
a user identifier for the third party user,
a plurality of attributes based on the information relating to the third party user, and
a plurality of attributes based on one or more of the user profiles.

15. A computer-readable medium storing instructions, the instructions comprising:
one or more instructions that, when executed by one or more processors of a device, cause the one or more processors to:
receive user information associated with users of user devices,
the user devices being associated with a service provider network;
receive marketing information associated with at least one of products or services,
the marketing information including information associated with advertisements for the at least one of products or services;
create user profiles, associated with the users, based on the user information;
receive information relating to a third party user,
the third party user being associated with a third party user device,
the third party user device being associated with a third party service provider network, and
the third party service provider network being different than the service provider network;
determine, based on the information relating to the third party user and the user profiles, a third party user profile for the third party user;
determine a particular advertisement to provide to the third party user device based on the third party user profile and the marketing information;
cause the particular advertisement to be provided to the third party user device, via the third party service provider network; and
receive, from the third party user device, feedback associated with the particular advertisement.

16. The computer-readable medium of claim 15, further comprising:
one or more instructions that, when executed by the one or more processors, cause the one or more processors to:
utilize the feedback to refine the third party user profile.

17. The computer-readable medium of claim 15, further comprising:
one or more instructions that, when executed by the one or more processors, cause the one or more processors to:
utilize the feedback to refine the determination of a future advertisement to provide to the third party user device.

18. The computer-readable medium of claim 15, where the one or more instructions for determining the particular advertisements further comprise:
one or more instructions that, when executed by the one or more processors, cause the one or more processors to:
assign weights to the marketing information;
calculate scores for the advertisements based on the assigned weights; and
select the particular advertisement, from the advertisements, based on the calculated scores for the advertisements.

19. The computer-readable medium of claim 15, where the one or more instructions for determining the third party user profiles further comprise:
one or more instructions that, when executed by the one or more processors, cause the one or more processors to:
utilize the user profiles in a machine learning algorithm; and
solve the machine learning algorithm, based on the user profiles and the information relating to the third party user, to determine the third party user profile.

20. The computer-readable medium of claim 15, further comprising:
one or more instructions that, when executed by the one or more processors, cause the one or more processors to:
determine the third party user profile based on a particular user profile associated with a particular user,
the particular user being associated with a particular user device; and
cause the particular advertisement to be provided to:
the third party user device, via the third party service provider network, and
the particular user device, via the service provider network.
